(19) United States
(12) Patent Application Publication
(10) Pub. No.: US 2026/0095657 A1
(43) Pub. Date: Apr. 2, 2026

(54) PTZ DRIVE APPARATUS AND METHOD FOR CAMERA

(71) Applicant: IDIS CO., LTD., Daejeon (KR)

(72) Inventors: Hyo Jin BYEON, Yongin-si (KR); Dong Sang YU, Icheon-si (KR); Hee Seok AHN, Seoul (KR)

(73) Assignee: IDIS CO., LTD., Daejeon (KR)

(21) Appl. No.: 19/284,711

(22) Filed: Jul. 30, 2025

(30) Foreign Application Priority Data
Sep. 30, 2024 (KR) 10-2024-0133126

(51) Int. Cl. H04N 23/695; H04N 23/62

(52) U.S. Cl. CPC H04N 23/695; H04N 23/62

(57) ABSTRACT

The present invention relates to a pan-tilt-zoom (PTZ) drive apparatus and method for a camera, and enables a surveillance region to be switched at high speed to a target region of interest using a previous PTZ control history, thereby enabling rapid movement to a surveillance region in which a specific surveillance target has been found or a specific event has occurred to obtain a desired surveillance image.

### CROSS-REFERENCE TO RELATED APPLICATION

This application claims priority to and the benefit of Korean Patent Application No. 10-2024-0133126, filed on September 30, 2024, the disclosure of which is incorporated herein by reference in its entirety.

### BACKGROUND

### 1. Field of the Invention

The present invention relates to a pan-tilt-zoom (PTZ) technique for a camera, and more particularly, to a PTZ drive apparatus and method for a camera that are capable of switching a surveillance region at high speed to a target region of interest using a previous PTZ control history.

### 2. Discussion of Related Art

Generally, in the case of surveillance pan-tilt-zoom (PTZ) cameras, since surveillance screens can be changed, surveillance regions may be changed to various locations to monitor surveillance targets (surveillance objects). In this case, in order to monitor a surveillance region in which a specific surveillance target has been found or a specific event has occurred, PTZ changes may frequently occur from a current surveillance region to the surveillance region in which the specific surveillance target has been found or the specific event has occurred. However, when the PTZ changes are automated, there is a concern about difficulties in setting or about detection of situations users do not want to monitor.

Meanwhile, in a case in which a user manually performs PTZ driving of cameras, although the PTZ driving can be performed at high speed that is faster than the user’s response speed because recent PTZ cameras have very fast response speeds, the PTZ driving may be performed at low speed corresponding to the user’s response speed. In this way, even though the PTZ driving can be performed at high speed, when the PTZ driving is performed at low speed corresponding to the user’s response speed, there is a problem in that a monitoring speed of a surveillance region is slow and a faster operation than the user’s response speed is impossible.

Further, as cameras having an artificial intelligence (AI) function have been developed recently, high-speed PTZ driving for rapidly tracking a surveillance target, enlarging a specific part of a surveillance target using the AI function, and the like is highly demanded. However, due to a limitation of a response speed corresponding to the user’s manual operation, there are many restrictions on high-speed PTZ driving, and thus a problem that rapid surveillance operations cannot be performed occurs. Therefore, the inventors of the present invention have studied a PTZ driving technique for a camera capable of switching a surveillance region at high speed to a target region of interest using a previous PTZ control history.

### Document of Related Art

### Patent Document

(Patent Document 0001) Korean Patent Registration No. 10-2700733 (Published on August 30, 2024)

### SUMMARY OF THE INVENTION

The present invention is directed to providing a pan-tilt-zoom (PTZ) drive apparatus and method for a camera that are capable of switching a surveillance region at high speed to a target region of interest (ROI) using a previous PTZ control history.

According to an aspect of the present invention, there is provided a PTZ drive apparatus for a camera, which includes a nonvolatile memory configured to store at least one piece of ROI information and at least one piece of PTZ control history information mapped thereto, an input device configured to receive a PTZ control input from a user, a processor configured to perform camera PTZ control in response to the PTZ control input, and a display unit configured to display a camera surveillance region image according to the camera PTZ control, wherein the processor includes a PTZ control history information search unit that searches for existence of PTZ control history information corresponding to the PTZ control input, and a high-speed PTZ driving unit that performs the camera PTZ control by switching a camera surveillance region at high speed to a target ROI recorded in the ROI information mapped to the PTZ control history information when the PTZ control history information corresponding to the PTZ control input exists.

The processor may further include a low-speed PTZ driving unit that performs the camera PTZ control while switching the camera surveillance region at low speed to the target ROI according to the PTZ control input when the PTZ control history information corresponding to the PTZ control input does not exist.

The processor may further include a PTZ control history learning unit that learns the PTZ control history information during a process of performing the camera PTZ control while switching the camera surveillance region at low speed to the target ROI, maps the learned PTZ control history information to the ROI information, and stores the mapped information in the nonvolatile memory.

When the PTZ control history information corresponding to the PTZ control input does not exist, the high-speed PTZ driving unit may be configured to search for target ROIs within a specific distance and specific angle range with respect to a PTZ control input direction (pan/tilt direction) corresponding to the PTZ control input, and perform the camera PTZ control by switching the camera surveillance region at high speed to any one target ROI selected from the found target ROIs.

The high-speed PTZ driving unit may be configured to select any one of the found target ROIs in consideration of at least one of distances to the target ROIs, observation frequencies for the ROIs, and a type of object of interest.

The processor may further include an artificial intelligence (AI) analysis unit that analyzes images of ROIs obtained by the camera.

The processor may further include a surveillance unnecessary region setting unit that sets a region in which surveillance is unnecessary and stores information on the set region in which surveillance is unnecessary in the nonvolatile memory.

The high-speed PTZ driving unit may be configured not to perform the camera PTZ control on the region in which surveillance is unnecessary.

According to another aspect of the present invention, there is provided a PTZ drive method for a camera, which includes storing at least one piece of ROI information and at least one PTZ control history information mapped thereto, receiving a PTZ control input from a user, searching for existence of PTZ control history information corresponding to the PTZ control input, and performing camera PTZ control by switching a camera surveillance region at high speed to a target ROI recorded in the ROI information mapped to the PTZ control history information when the PTZ control history information corresponding to the PTZ control input exists.

The PTZ drive method may further include performing the camera PTZ control while switching the camera surveillance region at low speed to the target ROI according to the PTZ control input when the PTZ control history information corresponding to the PTZ control input does not exist.

The PTZ drive method may further include learning the PTZ control history information during a process of performing the camera PTZ control while switching the camera surveillance region at low speed to the target ROI, mapping the learned PTZ control history information to the ROI information, and storing the mapped information.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a configuration of one embodiment of a pan-tilt-zoom (PTZ) drive apparatus for a camera according to the present invention; and

FIG. 2 is a flowchart illustrating a configuration of one embodiment of a PTZ drive method for a camera according to the present invention.

### DETAILED DESCRIPTION OF EXEMPLARY EMBODIMENTS

The above-described and additional aspects are embodied through embodiments described with reference to the accompanying drawings. It is understood that components of each embodiment are possible in various combinations within one embodiment or with components of another embodiment unless otherwise stated or inconsistent with each other. Based on the principle that the inventor can adequately define the concept of terms in order to describe his or her invention in the best possible way, terms used in this specification and claims should be interpreted as meanings and concepts consistent with the description or proposed technical concept.

Blocks expressed as “circuits” in this specification may be composed of hardware such as dedicated semiconductors, gate arrays, field-programmable gate arrays (FPGAs), etc., or parts thereof. One block or a plurality of blocks may be implemented as a single piece of hardware. As another example, these blocks may be implemented in software by an information processing device in which program instructions stored in memory elements are executed by computational elements. A plurality of blocks may be implemented as part of a program executed on the same computational element.

As another example, these blocks may be implemented in a hybrid form, where some individual circuits thereof are hardware and some are software. Further, in software implementation, computational elements may include digital signal processors, computational processors, artificial intelligence processing engines, artificial intelligence processors, graphics processors, or combinations thereof to the extent possible.

Hereinafter, in order to facilitate understanding and reproduction by those skilled in the art, the present invention will be described in detail by explaining exemplary embodiments with reference to the accompanying drawings. While specific embodiments are illustrated in the drawings and detailed descriptions related thereto are given, there is no intent to limit various embodiments of the present invention to the particular forms.

When it is deemed that detailed descriptions of related well-known functions or configurations may unnecessarily obscure the gist of the present invention, detailed descriptions thereof will be omitted.

It will be understood that when an element is referred to as being “connected” or “coupled” to another element, it can be directly connected or coupled to another element or intervening elements may be present.

In contrast, when an element is referred to as being “directly connected” or “directly coupled” to another element, there are no intervening elements present.

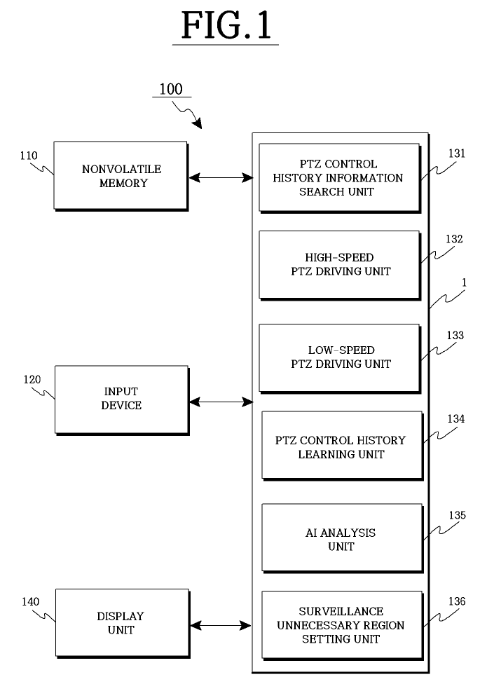

FIG. 1 is a block diagram illustrating a configuration of one embodiment of a pan-tilt-zoom (PTZ) drive apparatus for a camera according to the present invention. As illustrated in FIG. 1, a PTZ drive apparatus 100 for a camera according to the present invention includes a nonvolatile memory 110, an input device 120, a processor 130, and a display unit 140.

The nonvolatile memory 110 stores at least one piece of region of interest (ROI) information and at least one piece of PTZ control history information mapped thereto. In this case, the PTZ control history information may include pan driving angle information, tilt driving angle information, zoom level information, etc. Meanwhile, the nonvolatile memory 110 may be an electrically erasable programmable read-only memory (EEPROM), a flash memory, etc., but the present invention is not limited thereto.

Meanwhile, the ROI information may include coordinates of the center of a target ROI, and a surveillance region with an observation frequency (number of times monitoring per unit period) which is greater than or equal to a threshold value may be set as the target ROI.

The input device 120 receives a PTZ control input from a user. In this case, the PTZ control input may be user input information including a pan driving angle, a tilt driving angle, and a zoom level for PTZ driving of the camera.

Meanwhile, the input device 120 may be a user input interface such as a keyboard or mouse, a serial interface, a wired/wireless communication interface, or the like, but the present invention is not limited thereto.

The processor 130 performs camera PTZ control in response to the PTZ control input. In this case, the camera PTZ control may include pan control for driving the left and right rotation of the camera, tilt control for driving the up and down rotation of the camera, and zoom control for enlarging/reducing an image of the camera. Meanwhile, the processor 130 may include a single-core or multi-core based central processing unit (CPU).

In order to enable the surveillance region to be switched at high speed to the target ROI using a previous PTZ control history, the processor 130 includes a PTZ control history information search unit 131 in the form of hardware, software, or a combination thereof, and a high-speed PTZ driving unit 132.

The PTZ control history information search unit 131 searches for the existence of the PTZ control history information corresponding to the PTZ control input. In this case, the PTZ control history information search unit 131 may be implemented to search for the existence of the PTZ control history information corresponding to the PTZ control input by referring to at least one piece of PTZ control history information mapped to at least one piece of ROI information stored in the nonvolatile memory 110.

The high-speed PTZ driving unit 132 performs camera PTZ control by switching a camera surveillance region at high speed to a target ROI recorded in the ROI information mapped to the PTZ control history information when the PTZ control history information corresponding to the PTZ control input exists. In this case, the high-speed PTZ driving means performing PTZ driving of the camera at high speed that is equal or close to a response speed of the camera.

For example, the high-speed PTZ driving unit 132 may be implemented to pan and tilt a camera lens (not illustrated in the drawing) to the center location of the target ROI recorded in the ROI information mapped to the PTZ control history information corresponding to the pan driving angle, tilt driving angle, and zoom level that are included in the PTZ control input to switch the camera surveillance region at high speed to the target ROI and then enlarge or reduce the image of the camera according to the zoom level.

For example, the high-speed PTZ driving unit 132 may be implemented to pan and tilt the camera lens (not illustrated in the drawing) to the PTZ coordinates where an event is detected by artificial intelligence (AI) included in the PTZ control input to switch the camera surveillance region at high speed to the target ROI and then enlarge or reduce the image of the camera according to the set zoom level.

The display unit 140 displays a camera surveillance region image according to the camera PTZ control. In this case, the display unit may be a display such as a liquid-crystal display (LCD), a light-emitting diode (LED), an organic light-emitting diode (OLED), etc., but the present invention is not limited thereto.

By implementing the present invention in this way, it is possible to switch the surveillance region at high speed to the target ROI using the previous PTZ control history, and thus it is possible to rapidly switch to the surveillance region where a specific surveillance target has been found or a specific event has occurred and obtain a desired surveillance image.

Meanwhile, according to an additional aspect of the present invention, the processor 130 may further include a low-speed PTZ driving unit 133. The low-speed PTZ driving unit 133 performs the camera PTZ control while switching the camera surveillance region at low speed to the target ROI according to the PTZ control input when the PTZ control history information corresponding to the PTZ control input does not exist. In this case, the low-speed PTZ driving means performing PTZ driving of the camera at low speed that is equal or close to the user’s response speed.

By implementing the present invention in this way, when the PTZ control history information corresponding to the PTZ control input exists, the PTZ driving of the camera may be automatically performed at high speed through the high-speed PTZ driving unit 132, and when the PTZ control history information corresponding to the PTZ control input does not exist, the PTZ driving of the camera may be manually performed at low speed through the low-speed PTZ driving unit 133, thereby enabling stable PTZ driving control of the camera.

Meanwhile, according to an additional aspect of the present invention, the processor 130 may further include a PTZ control history learning unit 134. The PTZ control history learning unit 134 learns the PTZ control history information during a process of performing the camera PTZ control while switching the camera surveillance region at low speed to the target ROI, maps the learned PTZ control history information to the ROI information, and stores the mapped information in the nonvolatile memory 110.

By implementing the present invention in this way, when the PTZ control history information does not exist, it is possible to learn and store the PTZ control history information for automatically performing the PTZ driving of the camera at high speed while manually performing the PTZ driving of the camera at low speed through the low-speed PTZ driving unit.

Meanwhile, according to an additional aspect of the present invention, when the PTZ control history information corresponding to the PTZ control input does not exist, the high-speed PTZ driving unit 132 may be implemented to search for target ROIs within a specific distance and specific angle range with respect to a PTZ control input direction (pan/tilt direction) corresponding to the PTZ control input, and perform the camera PTZ control by switching the camera surveillance region at high speed to any one target ROI selected from the found target ROIs.

In this case, the high-speed PTZ driving unit 132 may be implemented to select any one of the found target ROIs in consideration of at least one of distances to the target ROIs, observation frequencies for the ROIs, and a type of object of interest. Meanwhile, the high-speed PTZ driving unit 132 may be implemented to assign weights to each of the distances to the target ROIs, the observation frequencies for the ROIs, and the type of object of interest, and select any one of the found target ROIs in consideration of the assigned weights.

In this embodiment, when the PTZ control history information corresponding to the PTZ control input does not exist, the target ROIs close to the PTZ control input may be searched for, and the camera PTZ control may be performed by switching the camera surveillance region at high speed to any one target ROI selected from the found target ROIs, thereby determining the most probable target ROI for the PTZ control input as the camera surveillance region.

Meanwhile, according to an additional aspect of the present invention, the processor 130 may further include an AI analysis unit 135. The AI analysis unit 135 analyzes images of ROIs obtained by the camera.

For example, the AI analysis unit 135 may be implemented to analyze images of the target ROIs close to the PTZ control input to detect objects such as persons or cars, and determine the camera surveillance region to be switched at high speed to the target ROI where a person has been detected, but the present invention is not limited thereto.

By implementing the present invention in this way, when switching the camera surveillance region at high speed to the target ROI, an AI analysis technique may be applied to rapidly and accurately determine the camera surveillance region to be switched at high speed.

Meanwhile, according to an additional aspect of the present invention, the processor 130 may further include a surveillance unnecessary region setting unit 136. The surveillance unnecessary region setting unit 136 sets a region in which surveillance is unnecessary and stores information on the set region in which surveillance is unnecessary in the nonvolatile memory 110.

Then, the high-speed PTZ driving unit 132 does not perform the camera PTZ control on the region in which surveillance is unnecessary. For example, when the high-speed PTZ driving unit 132 performs the camera PTZ control by switching the camera surveillance region at high speed to the target ROI recorded in the ROI information mapped to the PTZ control history information, the high-speed PTZ driving unit 132 may be implemented to determine whether the target ROI is the region in which surveillance is unnecessary by referring to the information on the region in which surveillance is unnecessary that is stored in the nonvolatile memory 110, and enable the camera PTZ control not to be performed when it is determined that the target ROI is the region in which surveillance is unnecessary.

By implementing the present invention in this way, it is possible to prevent movement of the surveillance region to the region in which surveillance is unnecessary by not performing the camera PTZ control on the region in which surveillance is unnecessary.

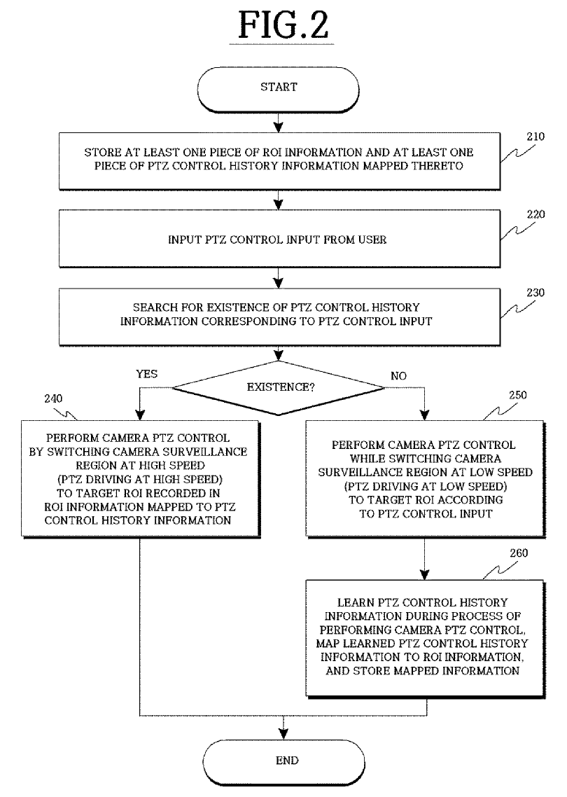

An operation of the PTZ driving of the PTZ drive apparatus for the camera according to the present invention as described above will be described with reference to FIG. 2. FIG. 2 is a flowchart illustrating a configuration of one embodiment of a PTZ drive method for a camera according to the present invention.

First, in operation 210, the PTZ drive apparatus for the camera stores at least one piece of ROI information and at least one piece of PTZ control history information mapped thereto. Since the PTZ control history information to be stored has already been described above, redundant descriptions thereof will be omitted.

Next, in operation 220, the PTZ drive apparatus for the camera receives a PTZ control input from a user. Since the PTZ control input has already been described above, redundant descriptions thereof will be omitted.

Next, in operation 230, the PTZ drive apparatus for the camera searches for the existence of PTZ control history information corresponding to the PTZ control input. Since the PTZ control history information to be searched for has already been described above, redundant descriptions thereof will be omitted.

Next, in operation 240, when the PTZ control history information corresponding to the PTZ control input exists, the PTZ drive apparatus for the camera performs camera PTZ control by switching a camera surveillance region at high speed (PTZ driving at high speed) to a target ROI recorded in the ROI information mapped to the PTZ control history information. Since the PTZ driving at high speed has already been described above, redundant descriptions thereof will be omitted.

By implementing the present invention in this way, it is possible to switch the surveillance region at high speed to the target ROI using the previous PTZ control history, and thus it is possible to rapidly switch to the surveillance region where a specific surveillance target has been found or a specific event has occurred and obtain a desired surveillance image.

Meanwhile, according to an additional aspect of the present invention, in operation 250, when the PTZ control history information corresponding to the PTZ control input does not exist, the PTZ drive apparatus for the camera may be implemented to perform camera PTZ control while switching the camera surveillance region at low speed (PTZ driving at low speed) to the target ROI according to the PTZ control input. Since the PTZ driving at low speed has already been described above, redundant descriptions thereof will be omitted.

By implementing the present invention in this way, when the PTZ control history information corresponding to the PTZ control input exists, the PTZ driving of the camera may be automatically performed at high speed, and when the PTZ control history information corresponding to the PTZ control input does not exist, the PTZ driving of the camera may be manually performed at low speed, thereby enabling stable PTZ driving control of the camera.

Meanwhile, according to an additional aspect of the present invention, in operation 260, the PTZ drive apparatus for the camera may be implemented to learn the PTZ control history information during a process of performing the camera PTZ control while switching the camera surveillance region at low speed to the target ROI, maps the learned PTZ control history information to the ROI information, and stores the mapped information. Since the learning of the PTZ control history information has already been described above, redundant descriptions thereof will be omitted.

By implementing the present invention in this way, when the PTZ control history information does not exist, it is possible to learn and store the PTZ control history information for automatically performing the PTZ driving of the camera at high speed while manually performing the PTZ driving of the camera at low speed through the low-speed PTZ driving unit.

As described above, in the present invention, it is possible to switch the surveillance region at high speed to the target ROI using the previous PTZ control history, and thus it is possible to rapidly switch to the surveillance region where a specific surveillance target has been found or a specific event has occurred and obtain a desired surveillance image, thereby achieving a purpose of the present invention presented above.

In the present invention, it is possible to switch a surveillance region at high speed to a target ROI using a previous PTZ control history, and thus it is possible to rapidly switch to a surveillance region where a specific surveillance target has been found or a specific event has occurred and obtain a desired surveillance image.

Various embodiments of the present invention disclosed in this specification and drawings are merely for providing a specific example to easily explain the technical contents of the present invention and are not intended to limit the scope of various embodiments of the present invention.

Therefore, the scope of various embodiments of the present invention should be interpreted as including all changes or modifications derived on the basis of the technical spirit of various embodiments of the present invention in addition to the embodiments disclosed herein.

### Industrial Applicability

The present invention can be used for industrial applicability in the field of pan-tilt-zoom (PTZ) related technology for a camera and its application technology.

What is claimed is:

1. A pan-tilt-zoom (PTZ) drive apparatus for a camera, comprising:
a nonvolatile memory configured to store at least one piece of region of interest (ROI) information and at least one piece of PTZ control history information mapped thereto;
an input device configured to receive a PTZ control input from a user;
a processor configured to perform camera PTZ control in response to the PTZ control input; and
a display unit configured to display a camera surveillance region image according to the camera PTZ control,
wherein the processor includes:
a PTZ control history information search unit that searches for existence of PTZ control history information corresponding to the PTZ control input; and
a high-speed PTZ driving unit that performs the camera PTZ control by switching a camera surveillance region at high speed to a target ROI recorded in the ROI information mapped to the PTZ control history information when the PTZ control history information corresponding to the PTZ control input exists.

2. The PTZ drive apparatus of claim 1, wherein the processor further includes a low-speed PTZ driving unit that performs the camera PTZ control while switching the camera surveillance region at low speed to the target ROI according to the PTZ control input when the PTZ control history information corresponding to the PTZ control input does not exist.

3. The PTZ drive apparatus of claim 2, wherein the processor further includes a PTZ control history learning unit that learns the PTZ control history information during a process of performing the camera PTZ control while switching the camera surveillance region at low speed to the target ROI, maps the learned PTZ control history information to the ROI information, and stores the mapped information in the nonvolatile memory.

4. The PTZ drive apparatus of claim 1, wherein, when the PTZ control history information corresponding to the PTZ control input does not exist, the high-speed PTZ driving unit searches for target ROIs within a specific distance and specific angle range with respect to a PTZ control input direction (pan/tilt direction) corresponding to the PTZ control input, and performs the camera PTZ control by switching the camera surveillance region at high speed to any one target ROI selected from the found target ROIs.

5. The PTZ drive apparatus of claim 4, wherein the high-speed PTZ driving unit selects any one of the found target ROIs in consideration of at least one of distances to the target ROIs, observation frequencies for the ROIs, and a type of object of interest.

6. The PTZ drive apparatus of claim 1, wherein the processor further includes an artificial intelligence (AI) analysis unit that analyzes images of ROIs obtained by the camera.

7. The PTZ drive apparatus of any one claim of claims claim 1, wherein the processor further includes a surveillance unnecessary region setting unit that sets a region in which surveillance is unnecessary and stores information on the set region in which surveillance is unnecessary in the nonvolatile memory.

8. The PTZ drive apparatus of claim 7, wherein the high-speed PTZ driving unit does not perform the camera PTZ control on the region in which surveillance is unnecessary.

9. A pan-tilt-zoom (PTZ) drive method for a camera, comprising:
storing at least one piece of region of interest (ROI) information and at least one PTZ control history information mapped thereto;
receiving a PTZ control input from a user;
searching for existence of PTZ control history information corresponding to the PTZ control input; and
performing camera PTZ control by switching a camera surveillance region at high speed to a target ROI recorded in the ROI information mapped to the PTZ control history information when the PTZ control history information corresponding to the PTZ control input exists.

10. The PTZ drive method of claim 9, further comprising performing the camera PTZ control while switching the camera surveillance region at low speed to the target ROI according to the PTZ control input when the PTZ control history information corresponding to the PTZ control input does not exist.

11. The PTZ drive method of claim 10, further comprising learning the PTZ control history information during a process of performing the camera PTZ control while switching the camera surveillance region at low speed to the target ROI, mapping the learned PTZ control history information to the ROI information, and storing the mapped information.
